(19) United States
(12) Patent Application Publication
(10) Pub. No.: US 2025/0091046 A1
(43) Pub. Date: Mar. 20, 2025

(54) Centrifugal Microfluidic Biochip

(71) Applicant: DERMAGNOSTIX GMBH, Friedberg (DE)

(72) Inventors: Katharina DORMANNS, Friedberg (DE); Lucca WEBER, Friedberg (DE); Verena HACKERT, Friedberg (DE); Natalie GARZORZ-STARK, Friedberg (DE)

(21) Appl. No.: 18/727,981

(22) PCT Filed: Jan. 10, 2023
(86) PCT No.: PCT/DE2023/100010

§ 371 Date: Jul. 10, 2024

(30) Foreign Application Priority Data
Mar. 22, 2022 (DE) 10 2022 106 693.2

(51) Int. Cl. B01L 3/00

(52) U.S. Cl. CPC B01L 3/50273; B01L 3/502715; B01L 2200/0689; B01L 2300/043; B01L 2300/046; B01L 2300/0609; B01L 2300/0803; B01L 2400/0409

(57) ABSTRACT

A centrifugal microfluidic biochip with a fluidic system formed from a plurality of chambers and/or conduits with an opening formed for introducing a biological sample into the fluidic system, including a fastener designed for fixing a sample carrier, having a biological sample and which covers the opening, to the centrifugal microfluidic biochip.

The invention relates to a centrifugal microfluidic biochip comprising a fluidic system formed by a plurality of chambers and/or conduits with an opening arranged for introducing a biological sample into the fluidic system.

Centrifugal microfluidic biochips, also known as centrifugal microfluidic bio-disks or centrifugal microfluidic test cartridges, are used in medical diagnostics as part of lab-on-a-chip or lab-on-a-disk systems. Such systems are known, for example, from DE 10 2013 203 293 B4, EP 2 416 B1, CN 109765391 A, CN 209680127 U and CN 209772148 U.

These centrifugal microfluidic biochips have a (micro) fluidic system into which a sample is introduced, which can be automatically processed according to a predetermined sequence protocol using an analyzer acting as a centrifuge, among other things, with a rotation device adapted to the bio-disc. Depending on the task to be processed, the Centrifugal Microfluidic Biochip will hold the appropriate reagents, which may be held in liquid form in stick packs, also known as sachets or sealed bags, air-dried or freeze-dried (lyophilized).

Using the known centrifugal microfluidic biochips, it is basically possible to automate labor-intensive and error-prone laboratory routines and carry out various work processes from sample preparation to data analysis in just one step. In particular, the known systems can be used to analyze patient samples much more quickly and accurately and to adapt therapy accordingly.

For example, EP 3 247 497 B1 describes a centrifugal microfluidic biochip equipped with the features mentioned at the beginning, which can accommodate a sampling instrument, in particular in the form of a swab, and analyze a biological sample adhering to it.

Although this centrifugal microfluidic biochip can be advantageous for processing some biological samples, the fundamental problem with taking samples from biological surfaces, which can be assigned primarily to the impression preparations used in dermatology and oncology, which enable rapid and cost-effective diagnostics, is that processing these samples in conjunction with a centrifugal microfluidic biochip means increased manual effort. The removed sample, which is taken in particular by means of an adhesive strip to be applied to the area to be examined, for example a lesion, an ulcerated skin change or a tumor incision or an infectious lesion, must first be further prepared, in particular shredded, for processing by a centrifugal microfluidic biochip before it can be introduced into a sample chamber of a centrifugal microfluidic biochip.

This additional preparatory activity increases the risk of contamination on the one hand, and on the other hand there is the problem that the shredded adhesive strips within the fluidic system tend to adhere to each other or to the walls of the fluidic system, so that the biological samples adhering to the adhesive strip are not accessible for analysis.

Therefore, it is an object of the invention to provide a solution to the above problem in such a way that biological samples adhering in particular to flat sample carriers can be completely analyzed by means of a centrifugal microfluidic biochip without contaminating the biological sample.

According to the invention, this object is solved by the centrifugal microfluidic biochip with the features of claim 1, the analysis system with the features of claim 9 and the method with the features of claim 12. The subclaims each describe advantageous embodiments of the invention.

The basic idea of the invention is not to introduce the sample carrier of an impression sample through an opening into a chamber of the fluidic system of a centrifugal microfluidic biochip, but to arrange the sample carrier with its side containing the biological sample on the outside of the centrifugal microfluidic biochip in such a way that the sample carrier at least partially covers the opening and the side of the sample carrier containing the biological sample can be washed over by fluids flowing along the opening in the fluidic system. The invention is particularly suitable for flat sample carriers, especially adhesive strips. These are preferably designed in such a way that they completely cover and span the opening in the fluidic system, with the sample carrier being fixed and secured to the centrifugal microfluidic biochip by a fastening means. The fastening means can be specially designed as a fastener, so that the sample carrier is not only fixed but also protected from external contamination, whereby the fluidic system is closed at the same time and leakage of chemical substances from the centrifugal microfluidic biochip is prevented. After processing, the Centrifugal Microfluidic Biochip can be disposed of in accordance with hygienic standards, resulting in an overall safe and efficient system.

Since the opening in the Centrifugal Microfluidic Biochip defines a predetermined area in relation to the sample carrier, it is also possible to relate the analysis to the area defined by the opening, so that not only qualitative but also quantitative statements can be made regarding the nature of a swab preparation.

According to the invention, a centrifugal microfluidic biochip, which can also be referred to as a centrifugal microfluidic bio-disk or centrifugal microfluidic test cartridge, is thus proposed with a fluidic system formed from a plurality of chambers and/or conduits with an opening arranged for introducing a biological sample into the fluidic system, which has a fastening means arranged for fixing a sample carrier to the centrifugal microfluidic biochip, the sample carrier having a biological sample and covering the opening. The fastening means is designed in particular as a clamp that attaches the sample carrier to the centrifugal microfluidic biochip. The sample carrier is designed in such a way that it at least partially covers the opening. Particularly preferably, the sample carrier has a surface that is larger than the surface formed by the opening, whereby the contour of the opening can be completely overlaid by the contour of the sample carrier surface. In other words, the sample carrier can preferably cover the opening completely, so that the opening of the centrifugal microfluidic biochip determines the area and thus the amount of biological sample adhering to the sample carrier, for example the (maximum) amount of cells or pathogens, which can be processed using the reagents provided in the fluidic system.

The fastening means is preferably set up to assume a first position that releases the opening and a second position that closes the opening either by itself or by means of the sample carrier.

The fastening means is not necessarily to be understood as a component permanently connected to the centrifugal microfluidic biochip, but can be detachably connected to the centrifugal microfluidic biochip according to an embodiment. It is therefore conceivable that the fastening means can be used repeatedly with a plurality of centrifugal microfluidic biochips so that this embodiment can be used in a resource-saving manner.

In particular, the fixing means is designed as a frame that can be inserted into a groove arranged around the opening. In particular, the frame can be designed as a punch which punches the section to be analyzed out of the sample carrier and at the same time fixes it to the centrifugal microfluidic biochip. The frame can be rectangular, but is preferably a ring that is arranged concentrically with the opening.

The opening can preferably be arranged in a recess, with the wall section of the centrifugal microfluidic biochip surrounding the opening forming a support surface for edge sections of the sample carrier. In particular, the geometric shape of the recess can be identical to the geometric shape of the sample carrier.

In any case, it is particularly preferred that the fastening means is a fastener which closes the opening in a fluid-tight manner, for example in the form of a cap or a lid, the fastener most preferably having an annular section in the form of a flange which can be inserted into a groove arranged around the opening in accordance with the aforementioned example, if necessary, by trimming the sample carrier. On the one hand, the clamping force of the fastener ensures that the sample carrier is fixed to the Centrifugal Microfluidic Biochip. On the other hand, the risk of contamination is reduced and the centrifugal microfluidic biochip is also protected against liquid leakage. In particular, the fastener is in full contact with the sample carrier and creates a secure seal against the fluidic system. To secure the fastening means to the centrifugal microfluidic biochip, latching means can preferably be provided.

A design that is very convenient to use is achieved if a hinge is provided for pivoting the fastening means relative to the centrifugal microfluidic biochip. This design enables simple and precise attachment of the fastening means to the centrifugal microfluidic biochip and thus of the sample carrier to the centrifugal microfluidic biochip.

The centrifugal microfluidic biochip is preferably designed as a disk having two base surfaces with a lateral surface arranged between them, whereby the opening is particularly preferably arranged in one of the base surfaces of the centrifugal microfluidic biochip designed as a disk. The opening in one of the base surfaces enables easy handling of the flat disk by placing the disk on a work surface and loading the sample carrier from above onto the base surface facing away from the work surface. After fixing the sample carrier to the Centrifugal Microfluidic Biochip and closing the opening by the sample carrier itself or by the fastening means designed as a fluid-tight fastener, the Centrifugal Microfluidic Biochip can be turned over so that the sample forms a bottom section of the fluidic system and can be easily washed over by fluid. In principle, an arrangement of the opening in the lateral surface is also conceivable, which would make it easy to bring the sample carrier into contact with fluid during rotation.

Furthermore, a coordinated analysis system with a centrifugal microfluidic biochip designed according to the invention and a sample carrier set up to hold a biological sample is proposed, whereby care must be taken to ensure that the sample carrier has a surface completely covering the opening of the centrifugal microfluidic biochip.

The sample carrier is in particular flat and specially designed as an adhesive strip, whereby the sample carrier particularly preferably has a layer arranged on a water-impermeable carrier layer, optionally having an adhesive mass, for holding a biological sample. The formation of a water-impermeable carrier layer enables the fastening means to be formed as a frame without the Centrifugal Microfluidic Biochip having to be additionally secured against liquid leakage.

Finally, a method for analyzing a biological sample by means of a centrifugal microfluidic biochip designed according to the invention or an analysis system designed according to the invention is proposed, wherein the centrifugal microfluidic biochip is set up in each case for analyzing the biological sample with respect to a predetermined task. The method according to the invention has the following steps:
Providing a biological sample adhering to a sample carrier;
Arranging the sample carrier at the centrifugal microfluidic biochip in such a way that liquid passing the opening in the fluidic system can come into contact with the biological sample;
Fixing the sample carrier to the Centrifugal Microfluidic Biochip using the fastener; and
Processing of the biological sample in a manner known per se with regard to a predetermined task.

Preferably, the processing comprises lysing the biological sample adhering to the sample carrier, wherein the lysing is particularly preferably carried out mechanically, chemically, enzymatically and/or with the application of heat. In particular, the use of a lysis buffer in ensures that the biological sample adhering to the sample carrier, in particular cells, are completely digested and accessible for analysis.

Alternatively, it may be provided that the processing comprises contacting the biological sample with a reagent, wherein the change in the reagent, which provides information about properties of the biological sample, is analyzed in a manner known per se.

The invention is explained in more detail below with reference to particularly preferred embodiments shown in the accompanying drawings. These show:

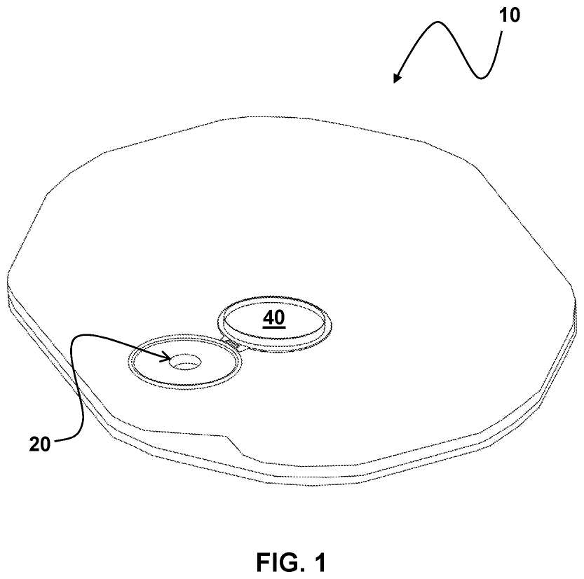

FIG. 1 a perspective view of a particularly preferred first embodiment according to the invention; and

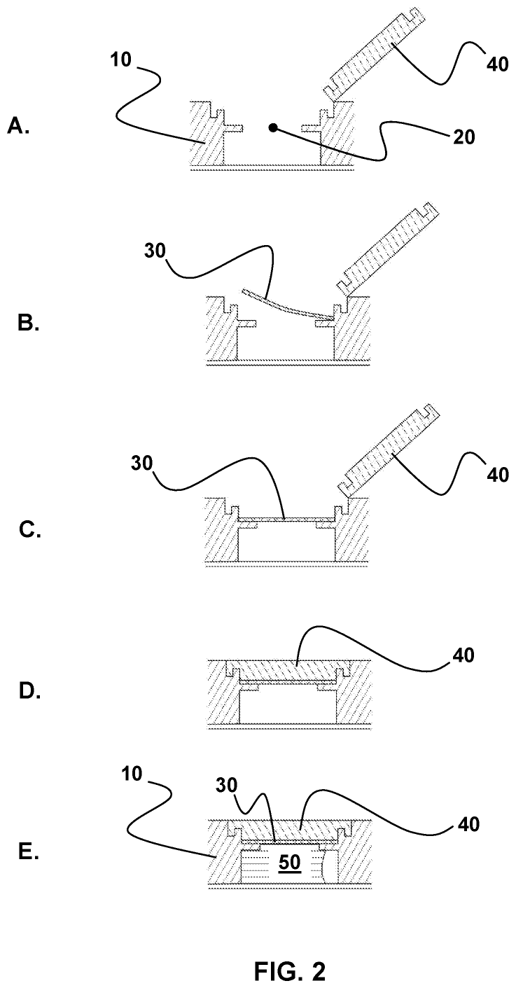

FIG. 2 a sectional view of a particularly preferably designed second embodiment according to the invention in the area of the fastening means designed as a fastener.

FIG. 1 shows a perspective view of a particularly preferably designed centrifugal microfluidic biochip according to the invention, albeit only shown schematically. The centrifugal microfluidic biochip 10 is designed as a disk having two base surfaces and a lateral surface arranged between them, wherein the opening 20 communicating with the fluidic system is arranged in one of the base surfaces of the centrifugal microfluidic biochip 10 designed as a disk.

The fastening means 40 fixing a sample carrier (not shown) to the centrifugal microfluidic biochip 10 can be pivoted relative to the centrifugal microfluidic biochip 10 by means of a hinge. In particular, the fastening means 40 is designed as a lid and has an annular flange extending from the plane of the lid, which can be inserted into a groove arranged on the centrifugal microfluidic biochip 10. From the position releasing the opening 20, the fastening means 40 can thus be transferred to a position closing the opening 20, in which not only the sample carrier (not shown) can be fixed to the centrifugal microfluidic biochip 10, but also the opening 20 can be closed in a fluid-tight manner.

Finally, FIG. 2 shows a sectional view of a particularly preferably designed second embodiment according to the invention in the area of the fastening means designed as a fastener.

In particular, FIG. 2 shows the procedure for attaching the sample carrier 30 to the centrifugal microfluidic biochip 10 in the area of the opening 20 set up to receive a biological sample. As described above, the centrifugal microfluidic biochip 10 has a fluidic system that is accessible to biological samples through the opening 20. In the example shown, the opening 20 can be completely closed by the fastening means 40 acting as a fastener. For this purpose, the fastening means 40—as shown in FIG. 2A—is connected to the centrifugal microfluidic biochip 10 via a hinge.

To process a biological sample, a flat sample carrier 30, on whose side facing the centrifugal microfluidic biochip 10 or the fluidic system of the centrifugal microfluidic biochip 10 the biological sample adheres, is placed in a recess in the base of the centrifugal microfluidic biochip 10. For this purpose, the wall surrounding the opening 20 to the fluidic system is designed as a support for the sample carrier 30, which rests on the support with its edge sections and otherwise covers the entire surface of the opening 20. The sample carrier 30 thus assumes the function of a wall that closes the opening 20.

If the sample carrier is correctly positioned, as shown in FIG. 2B and FIG. 2C, the fastening means 40, which acts as a fastener, can be folded against the centrifugal microfluidic biochip 10, as shown in FIG. 2D, whereby the sample carrier 30 is clamped between the support of the centrifugal microfluidic biochip 10 and the fastening means 40 and thereby fixed in its position.

Finally, FIG. 2E shows the centrifugal microfluidic biochip 10, in which the fluidic system is sealed fluid-tight by the fastening means 40 while fixing the sample carrier 30 spanning the opening, so that liquid 50 flowing past the sample carrier 30 can come into contact with the sample adhering to the sample carrier 30 and, in particular, can at least partially wash it off the sample carrier 30.

1. A centrifugal microfluidic biochip with a fluidic system formed from a plurality of chambers and/or conduits with an opening arranged for introducing a biological sample into the fluidic system, comprising:
a fastener arranged for fixing a sample carrier, having a biological sample and covering the opening, to the centrifugal microfluidic biochip.

2. The centrifugal microfluidic biochip according to claim 1, wherein the fastener is designed to assume a first position releasing the opening and a second position closing the opening itself or by the sample carrier.

3. The centrifugal microfluidic biochip according to claim 1, wherein the fastener is detachably connected to the centrifugal microfluidic biochip.

4. The centrifugal microfluidic biochip according to claim 3, wherein the fastener is designed as a frame configured to be inserted into a groove arranged around the opening.

5. The centrifugal microfluidic biochip according to claim 4, wherein the fastener closes the opening in a fluid-tight manner.

6. The centrifugal microfluidic biochip according to claim 5 further comprising a hinge arranged for pivoting the fastener relative to the centrifugal microfluidic biochip.

7. The centrifugal microfluidic biochip according to claim 6, wherein the centrifugal microfluidic biochip is designed as a disc having two base surfaces and a lateral surface arranged between them.

8. The centrifugal microfluidic biochip according to claim 7, wherein the opening is arranged in one of the base surfaces of the centrifugal microfluidic biochip formed as a disc.

9. An analysis system with the centrifugal microfluidic biochip according to claim 1 and a sample carrier set up to receive a biological sample, wherein the sample carrier has a surface completely covering the opening of the centrifugal microfluidic biochip.

10. The analysis system according to claim 9, wherein the sample carrier is an adhesive strip.

11. The analysis system according to claim 9, wherein the sample carrier has a layer arranged on a water-impermeable carrier layer for receiving a biological sample.

12. A method for analyzing a biological sample by a centrifugal microfluidic biochip according to claim 1, wherein the centrifugal microfluidic biochip is in each case set up to analyze the biological sample with regard to a predetermined task, comprising the steps of:
Providing a biological sample adhering to a sample carrier;
Arranging the sample carrier at the centrifugal microfluidic biochip in such a way that liquid flowing past the opening in the fluidic system can come into contact with the biological sample;
Fixing the sample carrier to the centrifugal microfluidic biochip using the fastener; and
Processing of the biological sample in a manner known per se with regard to a predetermined task.

13. The method according to claim 12, wherein the processing comprises lysing the biological sample adhering to the sample carrier.

14. The method according to claim 13, wherein the lysing is carried out mechanically, chemically, enzymatically and/or with the application of heat.

15. The centrifugal microfluidic biochip according to claim 1, wherein the fastener is designed as a frame configured to be inserted into a groove arranged around the opening.

16. The centrifugal microfluidic biochip according to claim 1, wherein the fastener closes the opening in a fluid-tight manner.

17. The centrifugal microfluidic biochip according to claim 1 further comprising a hinge arranged for pivoting the fastener relative to the centrifugal microfluidic biochip.

18. The centrifugal microfluidic biochip according to claim 17, wherein the centrifugal microfluidic biochip is designed as a disc having two base surfaces and a lateral surface arranged between them.

19. The centrifugal microfluidic biochip according to claim 18, wherein the opening is arranged in one of the base surfaces of the centrifugal microfluidic biochip formed as a disc.

20. The centrifugal microfluidic biochip according to claim 1, wherein the centrifugal microfluidic biochip is designed as a disc having two base surfaces and a lateral surface arranged between them.
